(19) United States
(12) Patent Application Publication
(10) Pub. No.: US 2012/0225630 A1
(43) Pub. Date: Sep. 6, 2012

(54) Systems and Methods for Antenna Tuning in a Mobile Device

(75) Inventor: Gregory A. Dunko, Cary, NC (US)

(73) Assignee: HTC, Taoyuan City (TW)

(21) Appl. No.: 13/039,695

(22) Filed: Mar. 3, 2011

(51) Int. Cl. H04B 1/18

(52) U.S. Cl. 455/193.1

(57) ABSTRACT

A system is described for tuning an antenna in a mobile device. The system comprises a detection module configured to interface with an accessory and identify the accessory. The system further comprises a tuner configured to retrieve one or more parameters according to the identified accessory, where the tuner is further configured to tune the antenna according to the one or more parameters. The one or more parameters are based on previously-derived information regarding tuning impairment characteristics of the accessory.

### TECHNICAL FIELD

The present disclosure generally relates to systems and methods for antenna tuning in mobile devices.

### BACKGROUND

In recent years, mobile devices such as smartphones and tablets have become widespread, and accessories are very common among individuals with mobile devices. Aside from the practical aspect of protecting a mobile device from damage, accessories such as cell phone covers offer a popular means of accessorizing or personalizing mobile devices. As such, accessories such as covers are readily available in a wide range of colors, shapes, materials, and sizes. In some cases, however, accessories such as cell phone covers may affect the transmission and/or reception performance of the phone antenna. With the rapid development in communication technology, smartphones and tablets have become an integral part of many people's lives given the portability of mobile devices, the convenient access to the Internet, and the growing number of applications available on such mobile devices. As such, it is important that mobile devices provide optimum performance, even when encased in a cover, as cellular reception is essential.

### SUMMARY

Briefly described, one embodiment, among others, is a system for tuning an antenna in a mobile device. The system comprises a detection module configured to interface with an accessory and identify the accessory. The system further comprises a tuner configured to retrieve one or more parameters according to the identified accessory. The tuner is further configured to tune the antenna according to the one or more parameters, where the one or more parameters are based on previously-derived information regarding tuning impairment characteristics of the accessory.

Another embodiment is a method for tuning an antenna in a mobile device. The method comprises detecting, by a detection module in the mobile device, that an accessory has been attached to the mobile device. In response to detecting the accessory, the accessory is identified. The method further comprises retrieving one or more parameters according to the identified accessory and retuning, by a tuner in the mobile device, the antenna according to the one or more parameters. In accordance with such embodiments, the one or more parameters are based on previously-derived information regarding tuning impairment characteristics of the accessory.

Another embodiment is a system that comprises a detection module configured to interface with an accessory and identify the accessory according to an identifier stored in the accessory. The system further comprises a tuner configured to retrieve one or more parameters stored in a memory of the mobile device according to the identified accessory. The tuner is further configured to tune the antenna according to the one or more parameters, where the one or more parameters are based on previously-derived information regarding tuning impairment characteristics of the accessory. The system further comprises an update checker configured to query a server for updates relating to accessories, the update checker being further configured to store updates in the memory of the mobile device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a mobile device and various examples of accessories that can be used with the mobile device.

FIG. 2 illustrates how various interfaces may be implemented between the mobile device and the accessory for identifying the accessory.

FIG. 3 is a block diagram of various components in the mobile device for retuning the antenna in the mobile device.

FIG. 4 illustrates an embodiment for querying a remote server for retuning parameters.

FIG. 5 illustrates another embodiment for querying a remote server for retuning parameters.

FIG. 6 illustrates an embodiment of the mobile device shown in FIG. 3.

FIG. 7 depicts a top-level flow diagram for a method of retuning the antenna in the mobile device of FIG. 3.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

In small mobile devices, the antenna design is optimized to maximize radiated performance across several different bands. The resultant frequency response tends to be reasonably flat within desired bands and then to fall off steeply at the band edges. In general, protective covers have a tendency to “detune” the device antenna, where the frequency response of the antenna is effectively shifted. In some cases, this detuning can push the response into the steep fall-off portion and result in many decibels (dB) of detuning of the antenna. This detuning means that the radiated power may be decreased, received sensitivity may be decreased, and overall radio frequency (RF) quality may be reduced.

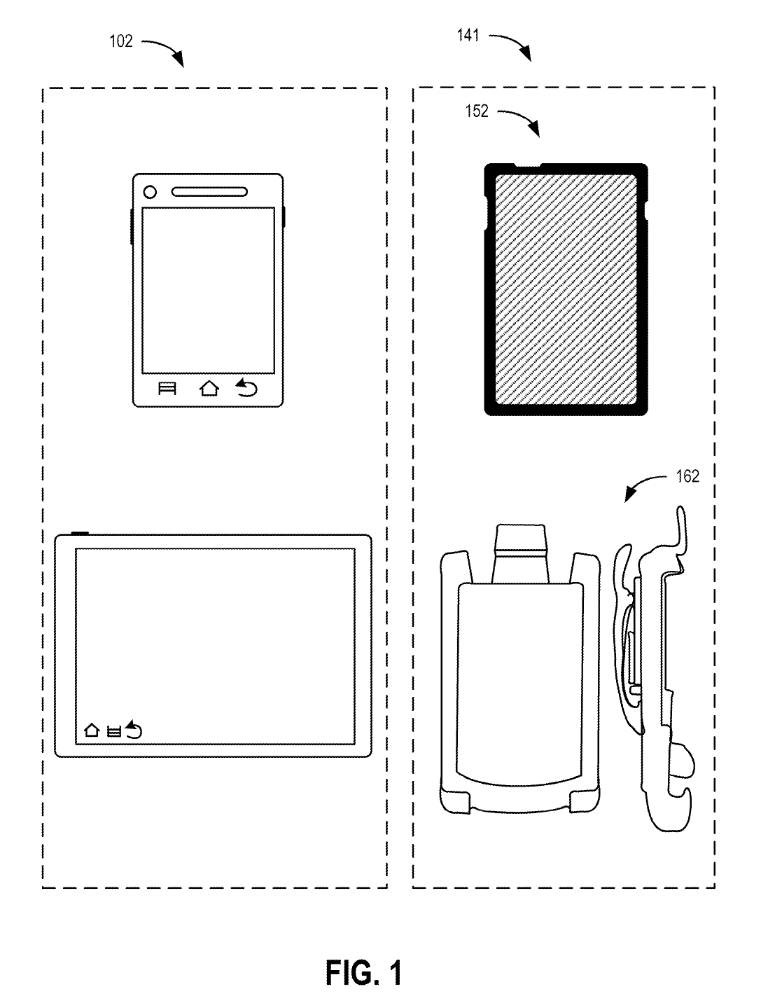

Embodiments are described for allowing an accessory to be attached to a mobile device where the mobile device maintains optimum performance while encased or attached to the accessory. Reference is made to FIG. 1, which shows a mobile device 102 and various types of accessories 141 that may be used with or on the mobile device 102. For purposes of this disclosure, a mobile device 102 generally refers to any mobile computing device, such as by of example and without limitation, a smartphone and a tablet. Furthermore, an accessory 141 may refer to any of a wide variety of covers, holsters, cases, skins, or other items that may be used to encase or hold the mobile device 102. For example, FIG. 1 depicts a commonly-used mobile device skin 152, which is typically constructed of rubber or some gel-type material. The skin 152 generally fits around the mobile device 102, thereby covering the sides or sides/backside of the mobile device 102. As noted earlier, this may degrade the performance of the antenna within the mobile device 102. Another example of an accessory 141 is a holster 162, which typically includes a belt clip so that individuals can attach the holster to a belt. While holsters 162 are typically constructed of a plastic material, some holsters 162 may be lined with a soft microfiber material to protect the mobile device 102 from scratches. Another example of an accessory 141 is a case-mate (not shown), the case-mate and the mobile device 102 basically conforms to the shape of each other.

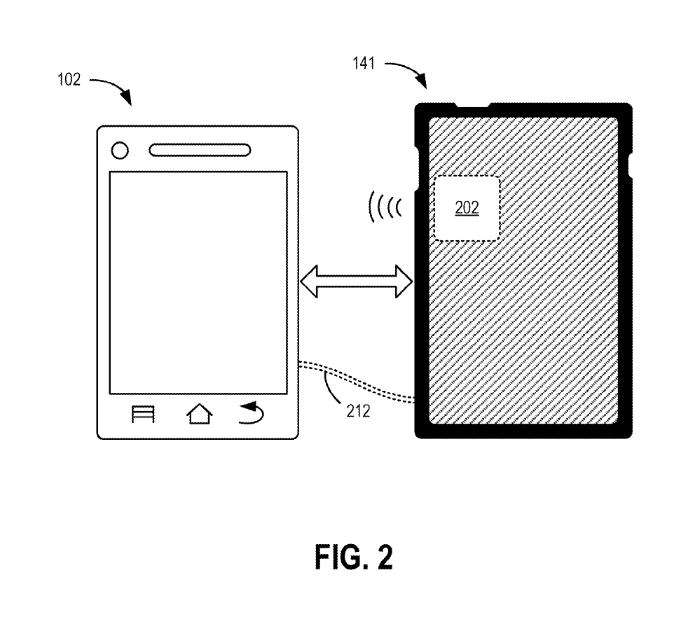

In accordance with exemplary embodiments, the mobile device 102 is configured to identify the accessory 141 to be coupled or attached to the mobile device 102. With reference to FIG. 2, various interfaces may be implemented for identifying an accessory 141. For example, some accessories 141 may include a connector or plug for connecting to the mobile device 102. The connector may comprise, for example, a micro-USB connector (not shown) used in conjunction with a cable 212 extending between the mobile device 102 and the accessory 141. For some embodiments, a built-in RFID tag 202 or other form of near field communication (NFC) may be used to transmit an identifier to the mobile device 102.

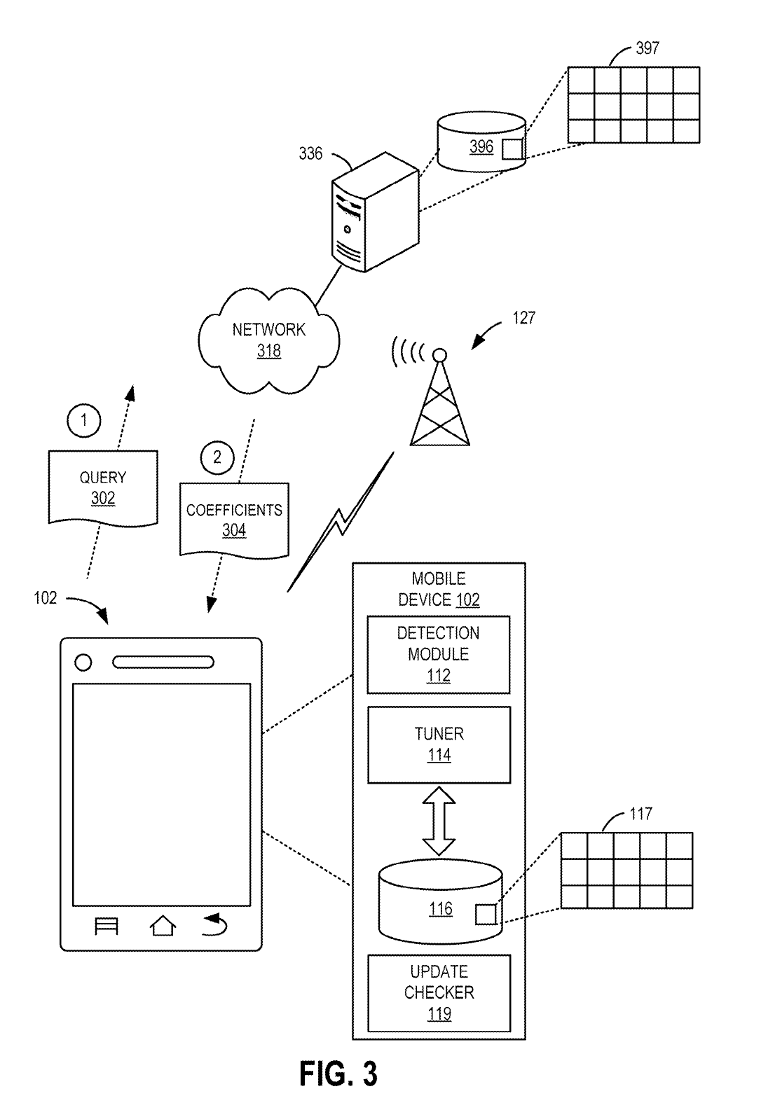

A description of a system for retuning the antenna in a mobile device 102 is now described followed by a discussion of the operation of the components within the system. FIG. 3 is a block diagram of a mobile device 102 configured to interface with the accessory 141 shown in FIGS. 1 and 2 and identify an accessory 141 to be attached to or used in conjunction with the mobile device 102. The mobile device 102 may be embodied as a mobile computing device, such as by of example and without limitation, a smartphone and a tablet. The mobile device 102 includes a detection module 112 configured to interface with the accessory 141 either through a wired or wireless connection. As described in connection with FIG. 2, the detection module 112 may receive or extract identification information from the accessory 141 through a number of means, including but not limited to, information transfer between the mobile device 102 and the accessory 141.

For example, where the accessory 141 comprises an active device that is battery-powered, the accessory 141 may be configured to transmit an identifier to the detection module 112 through a Bluetooth connection. Based on the identification of the accessory 141, a tuner 114 in the mobile device 102 retunes the antenna within the mobile device 102 as needed. Specifically, the tuner 114 utilizes parameters/coefficients derived based on known characteristics associated with the identified accessory 141 to optimize the radiated antenna performance while the accessory 141 is attached to the mobile device 102. The detection module 112 is also configured to determine when the accessory 141 is removed from the mobile device 102 and communicate this to the tuner 114, which then retunes the radiated antenna performance. For some embodiments, this retuning process may comprise simply resetting one or more antenna settings back to factory default settings.

For some embodiments, the tuner 114 may be configured to access memory 116 within the mobile device 102 and retrieve parameters or coefficients from a look-up table 117 or other data structure containing optimal antenna settings specific to various accessories. Using the identifier extracted by the detection module 112, the tuner 114 accesses the look-up table 117 to retrieve parameters/coefficients, which the tuner 114 then utilizes to retune the antenna of the mobile device 102. For some embodiments, the parameters/coefficients allow the mobile device 102 to “favor” certain frequency bands. For example, an accessory 141 offered by one particular carrier or wireless company may have associated parameters/coefficients that improve or maximize performance in the frequency bands used by that carrier.

In accordance with some embodiments, the mobile device 102 may also interface with a remote server 336 to retrieve the parameters/coefficients as an alternative (or in conjunction) to retrieving parameters/coefficients from local memory 116. As shown in FIG. 3, the mobile device 102 may be communicatively coupled to a server 336 via a network 318. The mobile device 102 may communicate with the server 336 via a cellular tower 127, local area network (not shown), or other means. The mobile device 102 submits a query 302 to the server 336 based on the identifier derived by the detection module 112. The server 336 then accesses a look-up table 397 in memory 396. The server 336 then transmits the parameters/coefficients 304 back to the mobile device 102 in response to the query 302.

The server 336 provides a centralized means for storing information on a wide variety of accessories 141. In accordance with some embodiments, a look-up table 117 may be stored on both the mobile device 102 and at a centralized server 336 in the event that cellular reception is not available. Note that while look-up tables are described in connection with the embodiments above, those skilled in the art will appreciate that other data structures may be utilized as well. For some embodiments, the mobile device 102 further comprises an update checker 119 configured to query the server 336 for updates to be applied to the look-up table 117 stored locally in the mobile device 102. The update checker 119 may be configured to query the server 336 on a periodic schedule. In other embodiments, the server 336 may transmit an indicator to the update checker 119 that an update is available, at which time the update checker 119 receives the update. The update checker 119 may also be configured to check for updates based on the occurrence of such key events as power on of the mobile device 102 and initiation of a network connection involving the mobile device 102. Updates may comprise parameters/coefficients relating to existing or newly-added accessories.

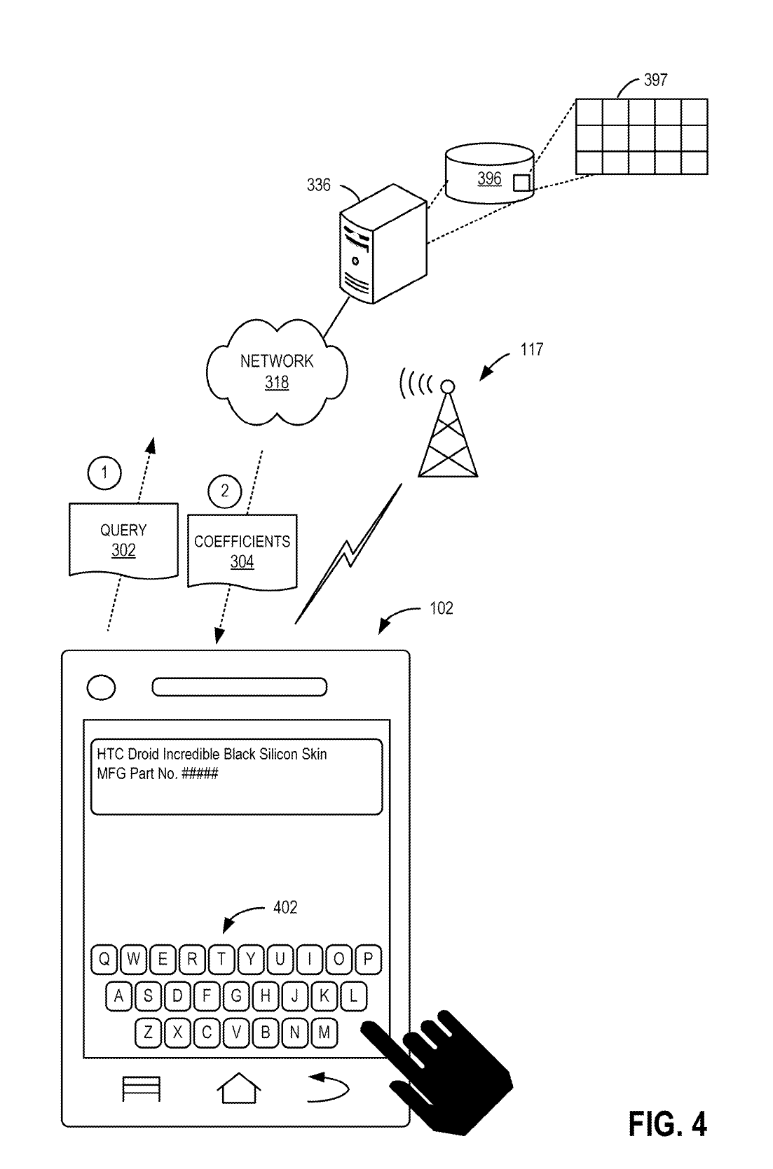

Reference is made to FIG. 4, which illustrates another means for retrieving parameters for retuning the antenna within the mobile device 102. Many mobile devices today include a QWERTY keyboard for users to input data, where the keyboard may comprise a physical keyboard or an onscreen keyboard 402 operated using a touchscreen. For some embodiments, the user may provide a description of the accessory 141 in FIG. 2. The description may comprise, for example, a general description of the physical characteristics of the accessory 141, a stock keeping unit (SKU) number, the manufacturing number, and so on. Based on the information input by the users, a query 302 is generated and submitted to the server 336, which sends retuning parameters/coefficients in response. As described above, the retrieval of parameters/coefficients may also be performed locally within the mobile device 102. Other means for inputting a description may also be implemented, including the use of voice command\control functions within the mobile device 102. For example, the user may dictate a description of the accessory 141 into the microphone of the mobile device 102, whereby the mobile device 102 generates a query 302 based on the description.

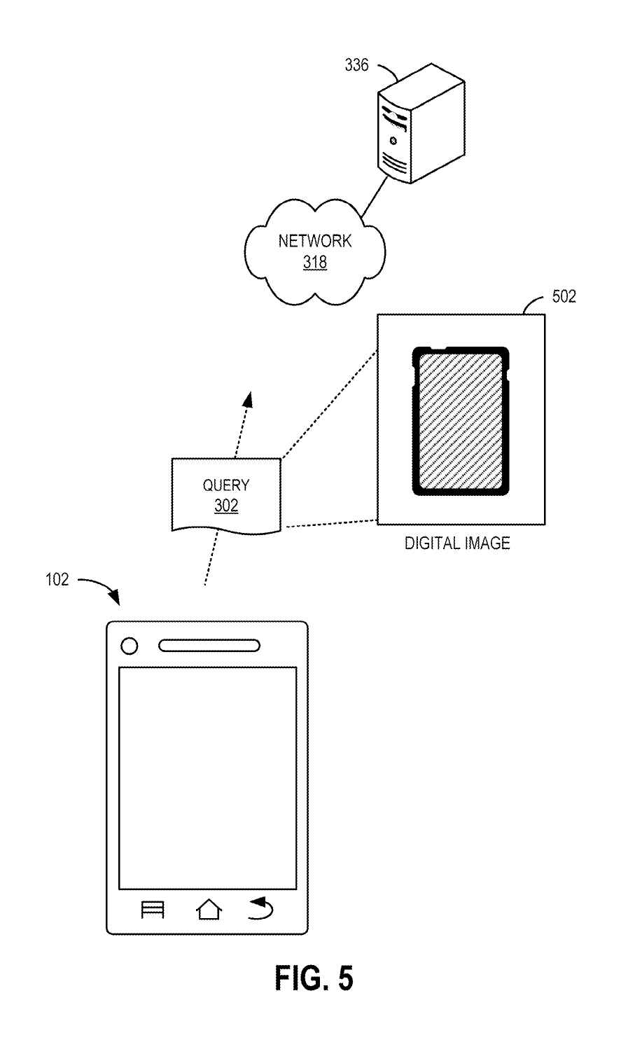

FIG. 5 illustrates another means for retrieving parameters for retuning the antenna within the mobile device 102. Many mobile devices 102 also include integrated digital cameras. For some embodiments, a digital image 502 of the accessory 141 (or accessory label\SKU) is captured by the mobile device 102. Using feature recognition software, the digital image 502 may be analyzed either locally at the mobile device 102 or remotely at the server 336 to identify the particular accessory 141. For some embodiments, the query 302 may comprise the digital image 502. Note that for some embodiments, the accessory 141 itself may store parameters/coefficients for retuning purposes. For such embodiments, the mobile device 102 interfaces with the accessory 141 and retrieves the information needed for the tuner 114 (in FIG. 3) to retune the antenna within the mobile device 102. The parameters/coefficients may be stored, for example, in an RFID tag.

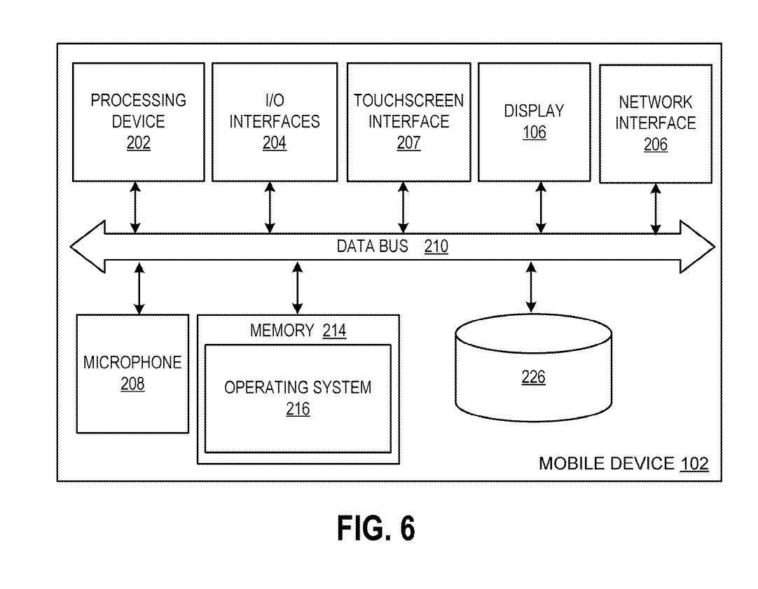

FIG. 6 illustrates an embodiment of the mobile device 102 described in connection with FIGS. 1-5. As described earlier, the mobile device 102 may be embodied as a smartphone and a tablet as well as any one of a wide variety of wired and/or wireless computing devices. As shown in FIG. 6, the mobile device 102 comprises memory 214, a processing device 202, a number of input/output interfaces 204, a network interface 206, a display 106, a touchscreen interface 207, a microphone 208, a camera (not shown), and mass storage 226, wherein each of these devices are connected across a local data bus 210. Those skilled in the art will appreciate that the mobile device 102 includes other devices not shown for purposes of brevity. The mobile device 102 may be configured to interface with the accessory 141 (in FIG. 1) through the input/output interfaces 204. For example, the mobile device 102 may be coupled to the accessory 141 via a wired or wireless connection, such as a USB connection via a USB, micro-USB, or mini-USB connector, a Bluetooth connection, and so on.

The processing device 202 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements. The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the mobile device 102 depicted in FIGS. 1-5. In accordance with such embodiments, the components are stored in memory 214 and executed by the processing device 202.

The touchscreen interface 207 is configured to receive input from a user via a display 106 and provides such functionality as on-screen buttons, menus, keyboards, etc. that allow users to navigate user interfaces by touch. One of ordinary skill in the art will appreciate that the memory 214 can, and typically will, comprise other components which have been omitted for purposes of brevity. As described earlier, voice command\control functions may be used to input information relating to a particular accessory. The microphone 208 shown in FIG. 6 receives verbal descriptions and/or commands from a user. For some implementations, the user input is processed by speech recognition software (not shown) stored in memory 214 and executed by the processing device 202. Note that in the context of this disclosure, a non-transitory computer-readable medium stores programs for use by or in connection with an instruction execution system, apparatus, or device. With further reference to FIG. 6, network interface device 206 comprises various components used to transmit and/or receive data over a networked environment such as the ones depicted in FIGS. 3-5.

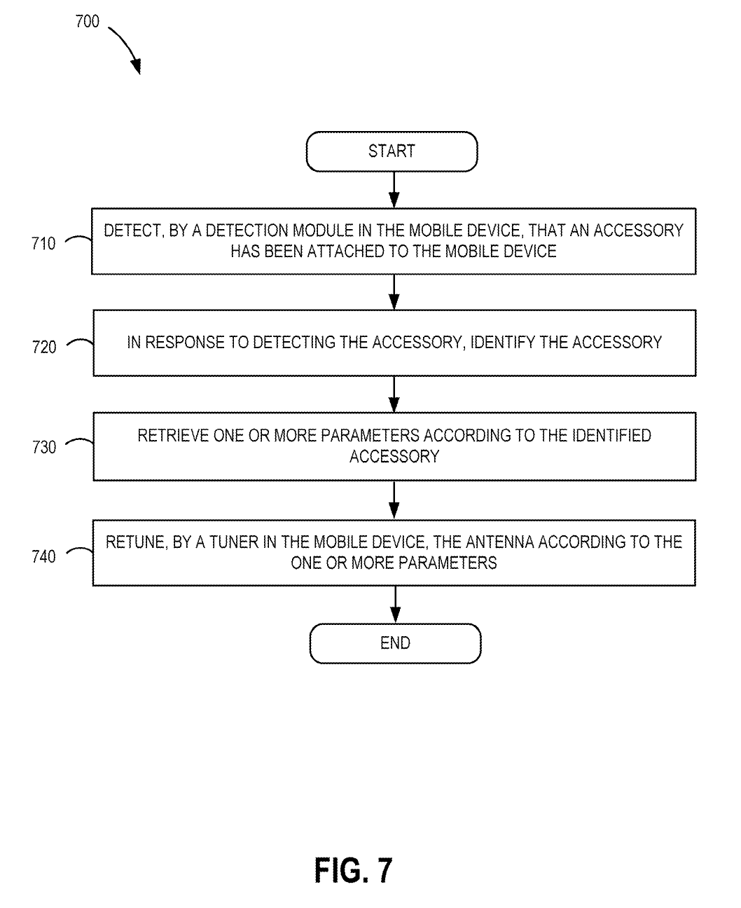

Reference is now made to FIG. 7, which is a flowchart 700 for a method for providing sensory feedback utilizing the devices shown in FIG. 1. If embodied in software, each block depicted in FIG. 7 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 102 shown in FIGS. 1-6. The machine code may be converted from the source code, etc. If embodied in hardware, each block may represent a circuit or a number of interconnected circuits to implement the specified logical function(s).

Although the flowchart 700 of FIG. 7 shows a specific order of execution, it is understood that the order of execution may differ from that which is depicted. In block 710, the detection module 112 shown in FIG. 3 detects that an accessory 141 has been attached to the mobile device. For some embodiments, the detection may be based on proximity of the accessory 141 with respect to the mobile device 102. In block 720, the accessory 141 is identified in response to detecting that an accessory 141 has been attached. In block 730, one or more parameters are retrieved according to the identified accessory 141. In block 740, the tuner 114 shown in FIG. 3 retunes the antenna according to the one or more parameters, where the one or more parameters are based on previously-derived information regarding tuning impairment characteristics of the accessory 141.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A system for tuning an antenna in a mobile device, comprising:
a detection module configured to interface with an accessory and identify the accessory; and
a tuner configured to retrieve one or more parameters according to the identified accessory, the tuner further configured to tune the antenna according to the one or more parameters,
wherein the one or more parameters are based on previously-derived information regarding tuning impairment characteristics of the accessory.

2. The system of claim 1, wherein the detection module is configured to interface with the accessory upon the accessory being within a predetermined proximity of the mobile device.

3. The system of claim 1, wherein the detection module is configured to interface with the accessory upon mobile device detecting a degradation in antenna radiation performance and upon determining that the accessory is within a predetermined proximity of the mobile device.

4. The system of claim 1, wherein the tuner retrieves the one or more parameters from a database stored in a memory within the mobile device.

5. The system of claim 4, wherein the database comprises a look-up table containing retuning parameters associated with one or more accessories.

6. The system of claim 1, wherein the detection module is further configured to determine if a previously detected accessory is no longer within a predetermined proximity of the mobile device.

7. The system of claim 6, wherein in response to the detection module determining that the previously detected accessory is no longer within the predetermined proximity, the tuner resets the tuner to previous settings.

8. The system of claim 1, wherein the tuner retrieves the one or more parameters from a database stored in memory of a remote server, wherein the tuner submits a query to the remote server to retrieve the one or more parameters.

9. The system of claim 8, wherein the tuner is communicatively coupled to the remote server via a cellular network.

10. The system of claim 1, wherein the tuner retrieves the one or more parameters from the accessory.

11. The system of claim 1, wherein the tuner retrieves the one or more parameters according to input received by the mobile device from a user, wherein the input corresponds to the accessory.

12. The system of claim 1, wherein the tuner retrieves the one or more parameters according to a digital image of the accessory captured by the mobile device.

13. A method for tuning an antenna in a mobile device, comprising:
detecting, by a detection module in the mobile device, that an accessory has been attached to the mobile device;
in response to detecting the accessory, identifying the accessory;
retrieving one or more parameters according to the identified accessory;
retuning, by a tuner in the mobile device, the antenna according to the one or more parameters,
wherein the one or more parameters are based on previously-derived information regarding tuning impairment characteristics of the accessory.

14. The method of claim 13, further comprising querying a remote server according to the identified accessory.

15. The method of claim 14, wherein querying the remote server comprises one of:
querying according to an identifier retrieved from the accessory;
querying according to user input relating to the accessory; and
querying according to a digital image of the accessory.

16. The method of claim 13, further comprising:
detecting, by the detection module, that the accessory has been removed from the mobile device;
resetting any previously adjusted one or more parameters to a previous setting; and
storing the retrieved one or more parameters for future access.

17. A system for tuning an antenna in a mobile device, comprising:
a detection module configured to interface with an accessory and identify the accessory according to an identifier stored in the accessory;
a tuner configured to retrieve one or more parameters stored in a memory of the mobile device according to the identified accessory, the tuner further configured to tune the antenna according to the one or more parameters, wherein the one or more parameters are based on previously-derived information regarding tuning impairment characteristics of the accessory; and
an update checker configured to query a server for updates relating to accessories, the update checker being further configured to store updates in the memory of the mobile device.

18. The system of claim 17, wherein the update checker is configured to query the server according to a periodic basis.

19. The system of claim 17, wherein the update checker is configured to query the server according to initiation of key events in the mobile device, wherein the key events comprise: power on of the mobile device, and initiation of a network connection involving the mobile device.

20. The system of claim 17, wherein the update checker is configured to query the server upon receiving an indication from the server that an update is available.

21. The system of claim 17, wherein if an identifier is not stored on the accessory, the mobile device prompts a user of the mobile device to enter a description of the accessory.
